(19) United States
(12) Patent Application Publication
(10) Pub. No.: US 2012/0186683 A1
(43) Pub. Date: Jul. 26, 2012

(54) ADJUSTABLE FLUID PRESSURE AMPLIFIER

(76) Inventor: Frederick Philip Selwyn, Bude (GB)

(21) Appl. No.: 13/261,243

(22) PCT Filed: Apr. 5, 2011
(86) PCT No.: PCT/GB2011/050673

§ 371 Date: Mar. 29, 2012

(30) Foreign Application Priority Data
Apr. 6, 2010 (GB) 1005685.1

(51) Int. Cl. F15C 1/06

(52) U.S. Cl. 137/833

(57) ABSTRACT

The amplifier includes a housing 2, 3 containing a chamber 4 provided with a delivery outlet 8 containing a non-return delivery valve 10. An inlet pipe 7 projects into the chamber 4 and a resilient obturator ring 13 is engaged with and located about the pipe to be resiliently-movable in the chamber. An annular exhaust aperture 12 surrounding the pipe can be sealed by the obturator ring 13, the obturator ring being responsive to fluid flow in the inlet pipe 7 such that fluid flow causes the obturator ring to oscillate between conditions which alternately permit and prevent fluid from leaving the chamber through the exhaust aperture 12 thereby causing a pulsed pressure increase in the fluid flowing through the delivery outlet. An adjuster 23 is provided for adjusting the distance by which the fluid inlet pipe 7 projects into the chamber and thus vary the distance between the obturator ring 13 and the annular exhaust aperture 12. The adjuster 23 is rotatably engaged with the pipe 7 and with the housing and moves the pipe using co-operably inclined faces. The obturator ring 13 and the delivery valve 10 are preferably shaped to create a venturi effect as fluid flows past them.

### TECHNICAL FIELD OF THE INVENTION

This invention relates to a fluid pressure amplifier.

### BACKGROUND

EP 0 891 491 A discloses a fluid pressure amplifier which includes a pipe having a fluid inlet and a fluid outlet and containing an array of holes. A chamber is formed around the pipe, surrounding the holes, with an obturator ring surrounding the pipe and resiliently-movable in the chamber to co-operate with an annular exhaust aperture surrounding the pipe which can be sealed by the ring. Fluid pressure in the pipe causes the ring to oscillate between conditions which alternately permit and prevent fluid from leaving the chamber through the exhaust aperture, causing a pulsed pressure increase in the fluid leaving the fluid outlet.

The fluid pressure amplifier can be used to increase the outlet pressure of fluid in a pipe where the inlet pressure is low, for example where the pipe is submerged in a river or connected to another low-pressure fluid source. Such an amplifier may be used in various situations, so that the pressure of the fluid source may vary and the required outlet pressure and/or volume may change.

The present invention seeks to provide a new and inventive form of fluid pressure amplifier which is compact, inexpensive, and is capable of being adjusted to accommodate different operating conditions.

### SUMMARY OF THE INVENTION

The present invention proposes a fluid pressure amplifier which includes a housing containing a chamber provided with a delivery outlet, an inlet pipe projecting into the chamber and terminating within the chamber, a resilient obturator ring engaged with and located about the pipe and resiliently-movable in the chamber, an annular exhaust aperture surrounding the pipe which can be sealed by the obturator ring, the obturator ring being responsive to fluid flow in the inlet pipe such that fluid flow causes the obturator ring to oscillate between conditions which alternately permit and prevent fluid from leaving the chamber through the exhaust aperture, thereby causing a pulsed pressure increase in the fluid flowing through the delivery outlet, and means for adjusting the distance by which the fluid inlet pipe projects into the chamber to vary the distance between the obturator ring and the annular exhaust aperture.

The obturator ring is preferably shaped in relation to the annular exhaust aperture to create a venturi effect as fluid flows between the two. This venturi effect substantially increases the pressure wave which is created when the obturator ring closes the exhaust aperture, thereby increasing the pressure achievable at the delivery outlet.

The delivery outlet preferably incorporates a non-return delivery valve, which is preferably also shaped to produce a similar venturi effect.

The chamber preferably includes at least one auxiliary port of relatively small cross-sectional area.

In a preferred form of the fluid pressure amplifier an adjuster is rotatably engaged with the pipe and with the housing such that the adjuster can vary the distance by which the fluid inlet pipe projects into the chamber using co-operably inclined faces. The inclined faces may be associated with the housing and/or the pipe and/or the adjuster itself.

### BRIEF DESCRIPTION OF THE DRAWINGS

The following description and the accompanying drawings referred to therein are included by way of non-limiting example in order to illustrate how the invention may be put into practice.

In the drawings:

FIG. 1 is a sectional view of a fluid pressure amplifier in accordance with the invention;

FIG. 2 is an enlarged cross sectional detail of part of the fluid pressure amplifier in the region of the obturator ring;

FIG. 3 is a cross section through three possible forms of obturator ring;

FIG. 4 is an enlarged cross sectional detail of part of the fluid pressure amplifier in the region of the delivery valve; and

FIG. 5 is a sectional view of an alterative means of adjustment which can be used in the fluid pressure amplifier.

### DETAILED DESCRIPTION OF THE DRAWINGS

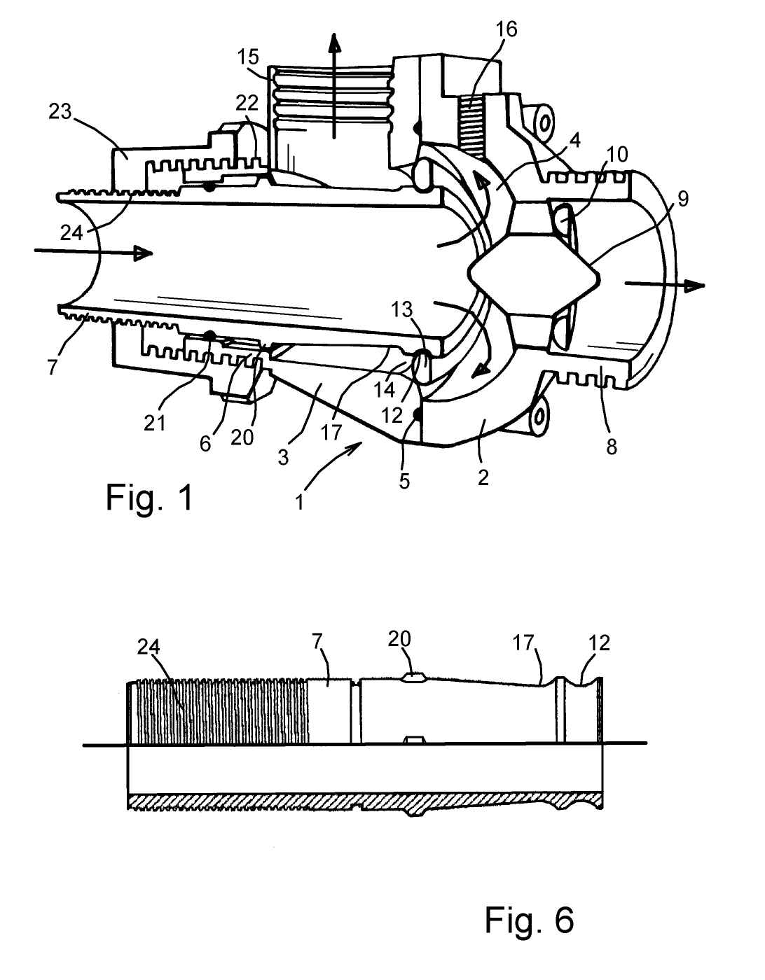

The fluid pressure amplifier is similar to a ram pump. Referring firstly to FIG. 1, the amplifier includes a housing 1 formed by front and rear moulded parts 2 and 3 which are bolted or otherwise secured together to define an internal chamber 4, sealed by an O-ring 5. The rear part 3 is formed with a sleeve 6 to receive an inlet pipe 7 which projects into the chamber 4 in alignment with a delivery outlet 8 moulded with the front part 2. The delivery outlet 8 is formed with a bi-conical guide 9 which provides a seat for a ring-shaped delivery valve 10, acting as a non-return valve.

The inner end of the pipe 7 has an external annular groove 12 within which is located a resilient obturator ring 13. The obturator ring co-operates with an annular aperture 14, formed by the rear part 3, which leads to a radial exhaust port 15. The front part 2 is also formed with a small-diameter auxiliary port 16 which may receive a pressure relief valve to prevent excessive pressure within the system and/or other auxiliary equipment such as an air pump which can be operated by hydraulic pressure pulses.

An additional groove 17 may be formed in the pipe 7 within the aperture 14 so as to increase the flow through the aperture.

The pipe 7 is formed with a guide rib 20 which centres the pipe and prevents it from rotating within the sleeve 6, and the pipe is sealed to the sleeve by a further O-ring 21. The sleeve 6 is formed externally with a coarse screw thread 22 onto which a differential adjuster nut 23 is threaded, and the rear end of the differential adjuster 23 is formed with an fine screw thread 24 which is, in turn, threadedly engaged with the pipe 7. In its normal rest condition there will be a gap between the obturator ring 13 and the annular aperture 14, but by rotating the differential adjuster 23 it is possible to move the pipe 7 in and out of the housing to accurately adjust the size of the gap.

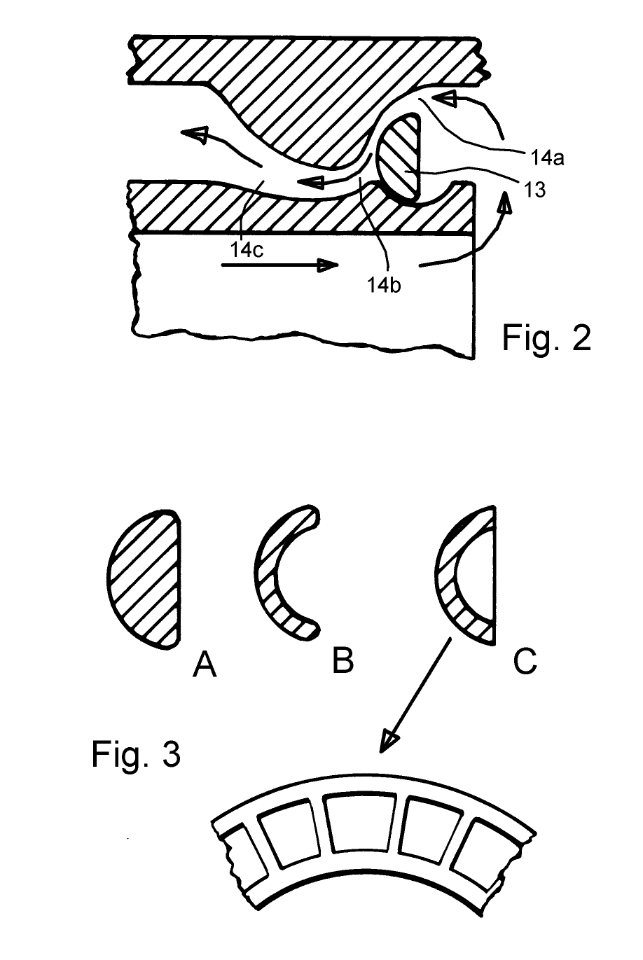

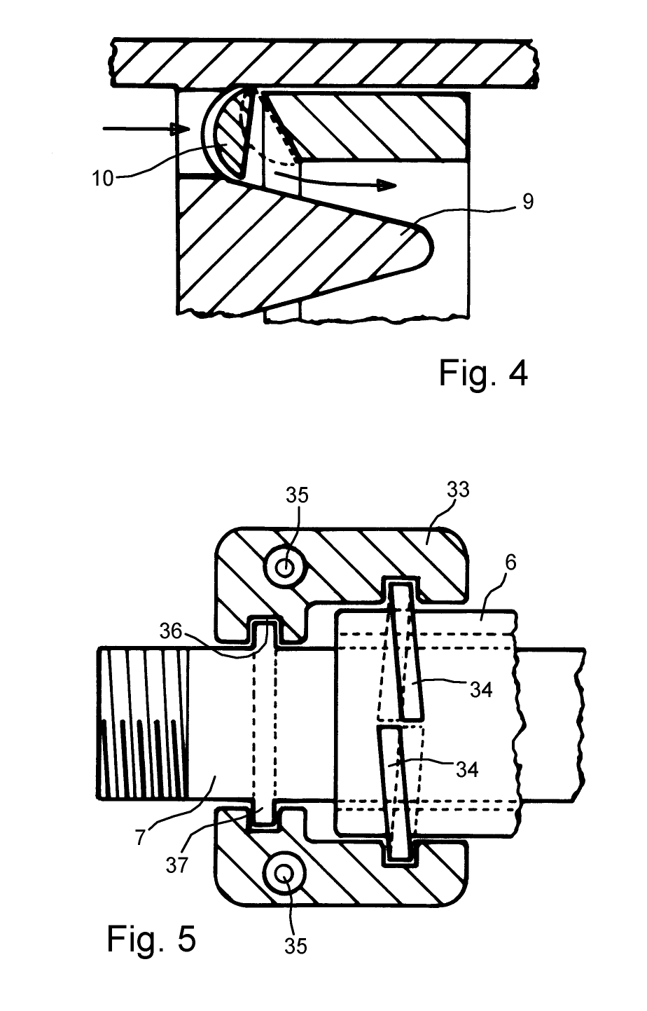

When a fluid such as water flows through the inlet pipe 7 it enters the chamber 4 and flows through the aperture 14 to exhaust. As shown in the cross-sectional detail of FIG. 2, the exhaust aperture 14 may be shaped to form a venturi or restriction as water flows through the exhaust aperture. In addition, the opposing faces of the obturator ring 13 and the exhaust aperture can be curved to create a venturi, such that as the flow increases between these two surfaces, low pressure is generated in this region causing the obturator ring 13 to be urged against exhaust aperture 14 by the pressure differential. It is also important to note that the venturi has a smooth profile, which enables the velocity of fluid entering the exhaust aperture to increase smoothly upon entering the valve, and decrease again smoothly on exiting from the valve, thus minimising turbulent flow and maximizing the efficiency of the pressure amplifier. FIG. 3 shows three example cross sections of the obturator ring 13, which in addition to being solid as in A, could also be of hollow D-shape as in B, or ribbed D-shape as in C. Hollow obturator rings maintain the integrity of the profile and the material from which it is formed whilst minimising the mass of the obturator ring in order to maximize the efficiency and durability of the obturator valve. The venturi effect enables a high flow rate to be produced through a relatively small valve opening, resulting in a high pressure wave upon closure of the obturator ring 13. This pressure wave causes the delivery valve 10 to open and creates a flow through the delivery outlet 8 at a higher pressure than the input pressure. As shown in FIG. 4, the delivery valve 10 can be shaped in the same way as the obturator ring 13 to produce a venturi effect in co-operation with the opposing surfaces of the fluid pressure amplifier so that the flow rate through the delivery valve can be maximized in relation to its area of opening. Increasing pressure causes the delivery valve element to distort angularly away from the opening, as shown in dashed outline, to allow maximum flow. When the pressure falls the delivery valve 10 resiliently snaps shut assisted by the back pressure. This creates a negative pressure in the chamber 4, allowing the obturator ring 13 to return to its starting position and re-open the exhaust flow through the aperture 14. The flow to the exhaust port then builds up again to repeat the cycle.

In operation, the fluid pressure amplifier can lift water to thirty or forty times the distance of the gravity head which produces a particular fluid pressure at the inlet pipe. Adjustment of the nut 23 allows the output flow and pressure to be “tuned” according to the input flow and pressure.

FIG. 5 shows an alternative way of adjusting the axial position of the pipe 6 using a cam adjuster 33. The sleeve 6 is formed externally with one or more inclined cam elements 34. The adjuster 33 is formed in two or more parts which are secured about the cam elements 34 by rivets or bolts 35. The rear end of the adjuster is formed with an internal annular groove 36 which receives an annular flange 37 formed on the pipe 7. By rotating the adjuster 33 the cam elements 34 act to move the cam axially of the sleeve 6 so that the cam adjuster carries the pipe 7 in and out of the housing.

Whilst the above description places emphasis on the areas which are believed to be new and addresses specific problems which have been identified, it is intended that the features disclosed herein may be used in any combination which is capable of providing a new and useful advance in the art.

1. A fluid pressure amplifier which includes a housing (1) containing a chamber (4), an inlet pipe (7) projecting into the chamber, a delivery outlet (8) communicating with the inlet pipe, a resilient obturator ring (13) engaged with and located about the inlet pipe and resiliently-movable in the chamber, an annular exhaust aperture (14) surrounding the inlet pipe which can be sealed by the obturator ring, the obturator ring (13) being responsive to fluid flow in the inlet pipe such that fluid flow causes the obturator ring to oscillate between conditions which alternately permit and prevent fluid from leaving the chamber through the exhaust aperture, thereby causing a pulsed pressure increase in the fluid flowing through the delivery outlet, and means (23) for adjusting the distance by which the fluid inlet pipe projects into the chamber to vary the distance between the obturator ring and the annular exhaust aperture,
characterised in that the inlet pipe (7) terminates within the chamber (4) and the delivery outlet (8) is fixed with the housing.

2. A fluid pressure amplifier according to claim 1 in which the annular exhaust aperture (14) is shaped to provide a gradual reduction in cross-sectional area leading smoothly into a section of gradually increasing cross sectional area, thereby creating a venturi effect as fluid flows through the aperture.

3. A fluid pressure amplifier according to claim 1 in which, when viewed in cross-section, the obturator ring (13) has a convex face directed towards the annular exhaust aperture (14) and an opposite face which is substantially flat or concave.

4. A fluid pressure amplifier according to claim 1 in which an adjuster (23) is rotatably engaged with the inlet pipe (7) and with the housing (1) such that the adjuster can vary the distance by which the fluid inlet pipe projects into the chamber using co-operably inclined faces.

5. A fluid pressure amplifier according to claim 4 in which the co-operably inclined faces are associated with the adjuster (23) and one or both of the housing (1) and the inlet pipe (7).

6. A fluid pressure amplifier according to claim 5 in which the co-operably inclined faces are provided by screw threads (22, 24).

7. A fluid pressure amplifier according to claim 6 in which the adjuster (23) is threadedly engaged with the housing (1) and the inlet pipe (7) using threads of different pitch (22, 24).

8. A fluid pressure amplifier according to claim 1 in which the delivery outlet (8) incorporates a non-return valve having a valve element (10) which co-operates with a valve seat (9) fixed with the housing (1).

9. A fluid pressure amplifier according to claim 8 in which the valve element (10) is ring-shaped and the valve seat (9) is provided by a bi-conical guide.

10. A fluid pressure amplifier according to claim 8 in which the valve element (10) is ring-shaped and co-operates with adjacent fixed surfaces to create a venturi effect which causes the valve element to deform such as to increase the flow rate through the non-return valve.

11. A fluid pressure amplifier according to claim 1 in which the chamber includes at least one auxiliary port of relatively small cross-sectional area.

12. A fluid pressure amplifier according to claim 1 in which the housing comprises two moulded parts which are releasably connected together, wherein one part provides the annular exhaust aperture (14) and the other part provides the delivery outlet (8).

13. A fluid pressure amplifier according to claim 1 in which the chamber (4) is substantially hemispherical.
